(19) United States
(12) Patent Application Publication
(10) Pub. No.: US 2018/0050963 A1
(43) Pub. Date: Feb. 22, 2018

(54) FLEXIBLE CEMENTITIOUS WATERPROOFING SLURRY

(71) Applicant: BASF SE, Ludwigshafen (DE)

(72) Inventors: Christoph HESSE, Ebersberg (DE); Klaus SEIP, Mutterstadt (DE)

(73) Assignee: BASF SE, Ludwigshafen (DE)

(21) Appl. No.: 15/556,663

(22) PCT Filed: Mar. 7, 2016
(86) PCT No.: PCT/EP2016/054792

§ 371 Date: Sep. 8, 2017

(30) Foreign Application Priority Data
Mar. 9, 2015 (EP) 15158208.7

(51) Int. Cl. C04B 28/06; C04B 26/04; C04B 14/06; C04B 14/28; C04B 24/26

(52) U.S. Cl. CPC C04B 28/065; C04B 26/04; C04B 14/06; C04B 2111/27; C04B 24/2623; C04B 24/2641; C04B 24/2676; C04B 14/28

(57) ABSTRACT

The present invention relates to novel cementitious slurries that remain flexible after hardening.

### FIELD OF THE INVENTION

Cementitious waterproofing slurries or slurry-type seal coatings are widely used in the construction industry. Generally they are used for waterproofing and protecting surfaces such as masonry or concrete and screed or tile covered bodies from penetrating water and other environmental influences.

### BACKGROUND OF THE INVENTION

The inventive coatings may be used as a coating agent for producing water-resistant coatings characterized in that the coating slurry contains one or more mineral binders, one or more polymers based on rubber or synthetic rubber, one or more filler agents and optionally one or more additives that may be required to fine-tune specific characteristics of the final product.

The term “cementitious” refers to hydraulic mineral binder containing components. The term “mineral binder” as used herein is intended to mean calcium silicate cements, ordinary Portland cements, puzzolanic cements, aluminate cements, calcium sulfoaluminate cements, slag cement, white Portland cement, masonry cement, waterproof cement, mixtures of the different cement types and similar hydraulic binder materials. Puzzolanic cements contain siliceous or siliceous and aluminous material from, e.g., volcanic origin, such as volcanic ash or pumice, or are obtained from clays, calcined oil shale or sedimentary rock, but also from industrial sources such as fly ash just to name a few of the materials that are used as additive in construction mixtures with hydraulic binder properties.

In the case where the mineral binder comprises a mixture of several hydraulic binder types, the mixtures are preferably of calcium aluminate and/or sulfoaluminate cement with blast furnace cement, filler cements or even mixtures with lime hydrate or gypsum or ordinary Portland cement. The term “calcium aluminate cement” (CAC) as used herein is intended to include those cementitious materials normally understood in the art to contain as main constituent mono calcium aluminate (CaOxAl2O3). This would include high alumina cement (HAC), calcium aluminate cement and many other commercially available aluminous types of cement. HAC is normally understood in the art to contain more than 15% of mono calcium aluminate. The term “calcium sulfoaluminate cement” (CSA) as used herein is intended to include those cementitious materials normally understood in the art to present special cements used for rapid set, high early strength development and shrinkage compensation. In particular calcium sulfoaluminate cements contain more than 15% of tetracalcium aluminate sulphate. This gives calcium sulfoaluminate cement the ability to achieve high early strength and continuous progressive strength development up to very high values (i.e. 60 MPa at 28 days). Its kiln production temperature generally is about 200° C. lower than for ordinary Portland cement, making it a socalled “low energy” cement.

Typically natural or synthetic latex or rubber may be used as the polymer dispersion in the inventive composition. Latex generally is an aqueous dispersion of polymer, wherein the polymer may be selected from natural or synthetic rubbers. Synthetic rubbers comprise polymers based on e.g. styrene acrylates or styrene and 1,3-butadiene (styrene-butadiene rubber; SBR). Further synthetic rubbers are butadiene rubber, neoprene, polysulfide rubbers (such as thiokols), butyl rubber and silicones. Other polymers such as poly vinyl acetate ((C4H6O2)n) which is prepared by polymerization of vinyl acetate monomer (VAC; free radical vinyl polymerization of the monomer vinyl acetate) and ethylene vinyl acetate (also known as EVA) is the copolymer of ethylene and vinyl acetate. The weight percent vinyl acetate usually varies from 10 to 40%, with the remainder being ethylene, carboxylated styrol butadienes (XSB) and other terpolymers or polymers composed of three different monomer units. Synthetic rubber based on styrene acrylate chemistry or any other type of artificial elastomer is mainly synthesized from petroleum byproducts. Different monomers are used for the manufacture of synthetic rubbers. SBR, VAC, EVA, styrene acrylate (SA), polyurethane (PU) and combinations thereof are commonly used in the waterproofing segment. Also styrene acrylates using styrene and specific types of acrylates like (n-butyl acrylate (nBA), ethyl hexyl acrylate (EHA) and methyl meth acrylate (MMA) are not uncommon. An elastomer is a material with the property that it can be stretched to great lengths and yet recover its original shape after the strain is released. Elastic materials will therefore return to their previous size and shape without permanent deformation.

Fillers typically utilized in the inventive composition are fine quartz sands of a grain size between 0.09 and 1 mm, lime stone powder of a grain size between 2 and 130 μm, calcium silica hydrate between 0.1 and 1 mm, sintered glass spheres between 0.05 and 0.6 mm or any other comparable filler a person skilled in the art would choose.

The composition may further contain additives. Additives may be selected from a wide variety of substances and compounds used to modify physical and chemical properties of the water-proofing slurries. Mineral thickeners like bentonite, acrylic thickeners, PU-thickener, hydrophobically modified alkali-swellable emulsion (HASE) thickener, cellulosic ether, starch ether, defoamers, hydrophobizing additives, retarders such as fruit acids or sodium gluconate and/or accelerators like calcium formate, cross linking agents like butanedioldiacrylat, allylmethacrylat, diacetoneacrylamid, 2-acetoacetoxyethylmethacrylat, glycidylmethacrylat, methallyl methacrylat or silane and activators to name a few. As activators alkaline activators are preferred, such as calcium hydroxide, sodium hydroxide, ordinary Portland cement or water soluble silicate compounds selected from sodium silicate, potassium silicate, waterglass, aluminium silicate, calcium silicate, silicic acid, sodium metasilicate, potassium metasilicate and mixtures of two or more of these constituents. Generally the water soluble silicate compounds are selected from alkali metasilicates of the formula m SiO2.nM2O, wherein M is Li, Na, K and NH4, preferably Na or K, or a mixture thereof, m and n refer to moles and the ratio of m:n is in the range of about 0.9 to about 4, preferably about 0.9 to about 3.8 and more preferred about 0.9 to about 3.6. The selection of additives may further be supplemented by any other additive known to the person skilled in the art.

Typically cementitious slurry-type waterproofing coatings are used in the construction or building industry for sealing and protection of the surfaces of any kind of artificial or construction structures by coating such structures with slurry-type waterproofing compositions that after hydration and hardening form membranes. The resulting membranes protect the underlying structures and prevent the penetration of water and other aqueous solutions, other non-aqueous liquids and/or gases such as carbon dioxide or sulfur dioxide. Furthermore cementitious slurry-type waterproofing membranes are also used beneath tiles and slabs of stone or other materials for example on balconies or terraces. In such cases the cementitious slurry-type water-proofing membranes functions not only as a waterproofing membrane, but also as a crack bridging layer and is applied directly to the concrete, masonry or other substrate surface. Further coverings of tiles and slabs are then laid thereon.

Basically cementitious slurry-type waterproofing membranes are products based on fine cement mortars with specific proportions of elastifying components. The products are applied in one or more layers. In many cases two layers, between 0.5 and 10 mm are applied. State of the art cementitious slurries complying with the industry standards [EN 14891 (12/2006), ETAG 022 (June 2005) or EN 1504-2 (July 2004)] comprise systems containing more than 10 weight % cement. The final waterproofing membranes have a thickness of more than 1 mm, particularly more than 2 mm.

In the construction business the use of slurry-type sealing coatings based on mineral binders, polymers and fillers for the coating of substrates is widespread and common and utilized as water-proofing membranes. In most cases the waterproofing formulations are compositions containing a bituminous component, a polymer-bitumen emulsion, a pure polymer emulsion or polymer powder as flexibilizing constituent. The mineral binder is generally used as a hydration agent and is contained in the formulations in the range of about 20-50 weight %.

Coating composition and formulations are described in U.S. Pat. No. 4,746,365. The disclosed formulations are gypsum containing compositions of aluminous cement as mineral binder system in addition with added latex emulsions to produce coating materials. These binder compositions are optimized such as to present reduced wet expansion and drying shrinkage of the final product. Not disclosed are binder compositions based on calcium aluminate and/or calcium sulfoaluminate cements with overall reduced cement content and respective utilization as flexible sealing slurries.

Waterproofing membranes are provided as either one-component (1K), polymer containing powders or as two-component (2K) formulations consisting of (i) a dry-component comprising the powdery or pulverulent constituents such as cement, sand, limestone powder etc. and (ii) a wet-component further containing polymer and potentially additional additives.

Typically the dry-component (i) of 2K sealing slurry systems contain:

0-50 weight % lime stone powder;

10-50 weight % silica sand,

30-50 weight % calcium silicate cement such as ordinary Portland cement,

0-20 weight % calcium aluminate cement and

0-10 weight % additives selected from one or more of anti-foaming agents, thickeners, activators, cross-linking agents, pigment, fiber etc.

The wet-component (ii) typically contains

30-70 weight % polymer,

0-10 weight % additives selected from one or more of anti-foaming agents, thickeners, activators, cross-linking agents, pigments etc.

Typical 1K sealing slurry formulations contain:

0-40 weight % lime stone powder;

20-75 weight % silica sand,

15-40 weight % calcium silicate cement such as Portland cement,

0-20 weight % calcium aluminate cement,

0-6 weight % calcium sulphate, alpha or beta semihydrate

0-40 weight % calcium hydroxide

10-40 weight % polymer,

0-7 weight % additives selected from one or more of anti-foaming agents, thickeners, activators, cross-linking agents, pigments, retardants, accelerants etc.

WO 2012/038302 provides formulation for coatings useful as durable and robust coatings of water-carrying infrastructures. The formulations are made-up of mineral binders, whereas the examples only provide formulations based on Portland cement. Preferably the polymer composition is a vinyl acetate-ethylene copolymer stabilized with polyvinyl alcohol. Not disclosed are binder compositions based on calcium aluminate and/or calcium sulfoaluminate cements in combination with styrene acrylates with overall reduced cement content and respective utilization as flexible sealing slurries.

WO 2013/050388 discloses dry building material formulations containing hydraulic binders, fillers and polymers that may be utilized for use as self levelling masses, tile adhesive and building masses in general. The formulations are further characterized by their content of silica sols, i.e. colloidal silica dioxide particles. Not disclosed are binder compositions based on calcium aluminate and/or calcium sulfoaluminate cements with overall reduced cement content and utilization as flexible sealing slurries.

U.S. Pat. No. 6,166,113 discloses flexible building compositions based on mineral binders and vinyl ester-ethylene mixed polymers that are stabilized by protective colloids. To flexibilize the building compositions the colloid stabilized vinyl ester ethylene copolymers are used. Not disclosed are binder compositions with reduced binder content based on calcium aluminate and/or calcium sulfoaluminate cements with overall reduced cement content and utilization as flexible sealing slurries.

EP 1,306,357 describes a water proof sealing mortar with improved durability. This is achieved by reducing the ordinary Portland cement content such that no continuous hydration matrix can be formed. In combination with polymers with high swelling capability a coating material is obtained that provides water-proofing and durability features.

Nevertheless the disclosed formulation fail to provide waterproofing slurries that after hydration remain flexible, present low shrinkage and provide durable crack-bridging properties.

### SUMMARY OF INVENTION

The binder system consists of cement and a polymer powder in the case of one component systems. The polymer constituent is responsible for the flexibility of the final product wherein the crack-bridging property of the product is achieved or based on this feature. This is one of the major advantages of flexible slurry-type waterproofing membranes over conventional rigid mineral-based waterproofing slurry coatings. The improved water-impermeability is another advantage of the inventive flexible waterproofing membranes.

These fast hardening binder systems are configured such that a minimum of one but at least two or more layers of membranes may be applied per day prior to the application of final surface coverings such as tiles for example. It may also be possible to utilize fast drying tile adhesives and even apply the final grouting, all in one day.

The polymer content necessary for final flexibility and crack-bridging property of the hardened membrane according to above mentioned industry standards will be over 20 weight %. Generally polymer contents are in the range of 25-30 weight %, or up to 70 weight %.

Cementitious waterproofing slurries are usually applied in two layers or coats either with brushes, swabs, trowels or sprayed resulting in dry thickness of approximately 1 mm per layer.

The cementitious waterproofing membranes of the invention may also be provided as either one-component (1K), polymer containing powder or as two-component (2K) formulations consisting of (i) a dry-component comprising the pulverulent constituents such as cementitious components, sand, limestone powder etc. and (ii) a wet-component further containing the polymer and potentially additional additives. The dry-component (i) of the inventive 2K sealing slurry systems contain:

0-50 weight % lime stone powder;

10-80 weight % silica sand,

1-50 weight % cementitious component and

0-10 weight % additives selected from one or more of anti-foaming agents, thickeners, activators, cross linking agents, pigment, fiber etc.

The wet-component (ii) typically contains

30-70 weight % polymer,

0-10 weight % additives selected from one or more of anti-foaming agents, thickeners, activators, cross linking agents, pigments etc.

adjusting to 100 weight % with water

The ratio of wet to dry component typically is found in the range of 1:2-3:1.

Typical 1K sealing slurry formulations contain:

0-40 weight % lime stone powder;

20-80 weight % silica sand,

1-45 weight % cementitious component,

10-40 weight % polymer,

0-7 weight % additives selected from one or more of anti-foaming agents, thickeners, activators, cross linking agents, pigments, retardants, accelerants etc.

Typically the dry one component (1k) type sealing slurry formulations are further admixed with water resulting in a 15-40 weight %, preferably 20-30 weight % of 1K sealing slurry compositions.

### DESCRIPTION OF THE INVENTION

The high content of calcium silicate cements in the classical waterproofing slurries as described above contravenes high flexibility of the resulting dried waterproofing membrane. In order to achieve flexibilities as demanded, very high contents of polymer are necessary. It is generally accepted that high calcium silicate cement contents are responsible for fast drying due to binding of the contained water via inherent hydration or curing of the cement constituents of the water-proofing slurries. Also the adhesion of the waterproofing slurry to underlying structures or substrates seems to be positively influenced by high calcium silicate contents.

X-ray diffraction measurements revealed that the cement turnover in cementitious water-proofing slurry compositions containing 50 weight % calcium silicate cement (Portland CEMI) and 28 weight % polymer after 24 hours and 7 days is less than 1 weight %. High cement content and low cement turnover rates in the traditional cementitious waterproofing slurry systems therefore results in a high degree of post hydration brittleness and strong shrinkage of the final hardened membrane.

Standard CSA cements are characterized by the early and fast ettringite formation that is responsible for strength development of such CSA-cements. The utility of the CSA-cements generally is restricted to specialty applications such as for screeds, tile adhesives etc. Uses for constructive applications have been hampered by lack of durability of the resulting building applications and instability under high water pressure or prolonged application submersed under water.

The deficits and disadvantages of the prior art can be overcome by the present invention as described herein.

The inventive binder system consists of cement and aqueous polymer dispersion in the case of two-component systems and of cement and a dry polymer dispersion powder in the case of one-component systems. A polymer/cement ratio of >0.6 of the resulting slurry is required in order to obtain the flexibility as demanded for sealant purposes in the construction business. The flexibility is a property of the waterproofing membranes that essentially serves for the bridging potential of surface cracks in the support or substrate on to which the membrane was applied according to European Standards EN 14891, EN 1504-2, European Technical Approval Guidelines (ETAG) 022 part 1, German certification of the building control authority (abP, allgemeines bauaufsichtliches Prüfzeugnis) and DIN 18195 (standard according to the German Institute for Standard “Deutsches Institut fur Normung e.V.).

The problem to be solved by the present invention was to provide an improved formulation for stable and flexible slurries, preferably water-proofing membranes wherein the final cured coatings have reduced brittleness and shrinking capacity. The inventive waterproofing slurries therefore are ideal for providing waterproofing and coatings with superior crack-bridging property.

The choice of the cement type has substantial influence on the properties of the end product, i.e. the cured waterproofing membranes. Substitution and/or replacement of calcium silicate cement amounts with calcium sulfoaluminate or calcium aluminate cement in the sealing slurry formulations had surprising effects with regard to the brittleness of the cured product. In particular the reduction of the cement content below 10 weight % substantially reduces brittleness and shrinkage behavior of the material. Calcium sulfoaluminate and calcium aluminate cements as cementitious component of the inventive waterproofing membrane lead to a product with improved durability, flexibility and water resistance and stability compared to waterproofing slurries based primarily on ordinary Portland cements. The inventive mixtures contain up to 100 weight %, preferably 1-50 weight % more preferred 3-15 weight % or even more preferred 5-10 weight % calcium sulfoaluminate cement.

Further, the choice and grain size of the mineral fillers also has substantial influence on the drying, curing and flexibility behavior of the membrane.

Polymer or latex powder is selected from the group consisting of vinyl acetate polymer, vinyl acetate-ethylene copolymer, vinyl acetate-vinyl ester copolymer and/or vinyl acetate-vinyl ester-ethylene copolymer, with the vinyl ester monomers in each case being selected from the group consisting of vinyl laurate, vinyl pivalate and vinyl versatates, vinyl acetate-acrylic ester copolymer, vinyl acetate-acrylic ester-ethylene copolymer, styrene-butadiene copolymer and styrene-acrylic ester copolymer, with the acrylic esters in each case being esters with branched or linear alcohols containing from 1 to 10 carbon atoms. Preferably the latex powder is selected from the group comprising styrene acrylate copolymer, polyvinyl acetate, styrene butadiene copolymer or mixtures thereof.

A further advantage of the inventive formulations is the reduced amount of additives required to obtain optimal functionality. For example the resulting dry formulations based on the inventive recipes may easily be stored for longer time periods without the need of adding additional anti-caking additives as in conventional formulations. This has beneficial effects in reducing the costs of manufacturing.

It was found that good absorption of spray drying additives like polyvinyl alcohol, sulfonates or polycarboxylates and emulsifiers is fundamental for an adequately high wet-strength of the utilized polymer in the formulation. Especially dispersant polymers with a high content of water sensitive spray drying additives of 3-15 weight % present high absorption on the surface of the Calcium sulfoaluminate and calcium aluminate cements. The absorptive capacity can be determined by measuring the total organic content of test formulation with or without respective spray drying additives in the cement emulsions. For the analysis of total organic content the test formulation is prepared and after five minutes the liquid is separated from the solid by high pressure through a filter. In the resulting liquid the organic carbon content is determined with a total organic carbon (TOC) analyzer conform to the standard DIN EN 1484 requirements with respective combustion equipment.

The absorptive capacity of calcium aluminate cements lies in the range of 50-80 weight % whereas in contrast thereto the absorptive capacity of Portland cement is merely in the range of 10-25 weight %.

For the selection of an appropriate cement types useful in reduced cementitious flexible water-proofing membranes the absorptive capacity of the cement is crucial. Cements with high absorptive rates are preferred.

It has been demonstrated that calcium sulfoaluminate cements with low calcium sulfate contents, preferably mixtures that are free of calcium sulfate are superior for use in highly cement reduced sealing slurry formulations and have very good absorptive properties.

The inventive cementitious water-proofing slurries may also be utilized for producing or manufacturing stable and highly flexible water-proofing membranes. Such water-proofing membranes may optionally contain a base fabric or matrix which is coated on one or both sides with the inventive composition as a coating to form a non-permeable barrier. Such water-proofing membranes may be composed of one or more layers of each cementitious water-proofing slurry and/or base fabric or matrix and constitute a single or multiple ply membrane. Alternatively the flexible water-proofing membranes may be prepared by immersing a base fabric or matrix into a bed of cementitious water-proofing slurry, the slurry evenly spread out whereby the slurry and base fabric or matrix combine and form a single foil or wallpaper-like element. These water-proofing membranes can be used in various construction and architectural applications. These types of membranes are generally designed for direct installation, with or without combination with any other layers or materials to provide a waterproof barrier. The base fabric or matrix may be selected from woven, knitted or non-woven natural or polymeric fibers, glass fibers, a polymeric adhesive coating, and optionally a polymeric coating on one or both sides of the base fabric. The resulting flexible water-proofing membranes can be manufactured or prefabricated in the form of a foil or wallpaper of controlled quality and stored for further use. Such a prefabricated foil can be utilized as a wallpaper providing for example an immediate to use underground for further tiling without the need of waiting several hours of drying before tile adhesive can be applied as required for standard water-proofing slurries.

The invention of the present application may be partially characterized by reference to this nonexclusive list of exemplary item. As envisioned in the present invention with respect to the disclosed compositions of matter and methods, in one aspect the embodiments of the invention comprise the components and/or the steps disclosed herein. In another aspect, the embodiments of the invention consist essentially of the components and/or steps disclosed herein. In yet another aspect, the embodiments of the invention consist of the components and/or steps disclosed herein:

1: A composition for sealing slurries comprising:

(i) 1-50 weight %, preferably 2-15 weight %, more preferred 3-10 weight %, most preferred 3-5 weight % hydraulic binder component

(ii) 40-77 weight % silica sand

(iii) 10-40 weight %; preferably 15-30 weight %, most preferred 18-20 weight % polymer

(iv) 5-20 weight % limestone powder

(v) 0-5 weight % one or more additives

characterized in that the hydraulic binder component comprises, or consists essentially of or consists of up to 100 weight % of calcium aluminate cement or calcium sulfoaluminate cement or mixtures of calcium aluminate cement and calcium sulfoaluminate cement and the polymer is selected from the group consisting of vinyl acetate polymer, vinyl acetate-ethylene copolymer, vinyl acetate-vinyl ester copolymer and/or vinyl acetate-vinyl ester-ethylene copolymer, with the vinyl ester monomers in each case being selected from the group consisting of vinyl laurate, vinyl pivalate and vinyl versatates, vinyl acetate-acrylic ester copolymer, vinyl acetate-acrylic ester-ethylene copolymer, styrene-butadiene copolymer and styrene-acrylic ester copolymer, with the acrylic esters in each case being esters with branched or linear alcohols containing from 1 to 10 carbon atoms, preferably the polymer is selected from the group comprising styrene acrylate copolymer, polyvinyl acetate, styrene butadiene copolymer or mixtures thereof. or other terpolymer in liquid or powder form.

2: A composition of Item 1 wherein the hydraulic binder component comprises or consists essentially of calcium aluminate cement and calcium sulfoaluminate cement.

3: A composition as in item 1 or 2, wherein the hydraulic binder component consists of up to 100, 95, 90, 85, 80, 75, 70, 65, 60, 55, or 50 weight % calcium sulfoaluminate cement.

4: A composition as in item 3 wherein the hydraulic binder component consists of up to 80, preferably up to 85 weight % calcium sulfoaluminate cement and is free of Portland cement.

5: A composition of any one of the items 1-3 wherein the hydraulic binder component may further contain Portland cement.

6: A composition of Item 5 wherein Portland cement and calcium sulfoaluminate cement are present and the ratio of calcium sulfoaluminate cement:Portland cement is higher than 5, more preferred higher than 10.

7: A composition of any of the Items 1-3 wherein the hydraulic binder component comprises, or consists essentially of or consists of a calcium aluminate cement and calcium sulfoaluminate cement mixture.

8: A composition of any one of the items 1-7 wherein the polymer comprises or consists essentially of styrene acrylate or an acrylate copolymer.

9: A composition of any one of the items 1-8, wherein the ratio of polymer:cement is larger than 0.6, preferably larger than 1.5, preferably larger than 2, preferably larger than 2.5, preferably larger than 3, most preferred larger than 3.5.

10: A two component (2K) sealing slurry system composition of any of the items 1-9 comprising:

(i) dry components

5-20 weight % lime stone powder;

40-77 weight % silica sand,

1-50 weight % hydraulic binder component,

0-10 weight % additives selected from one or more of anti-foaming agents, thickeners, activator, cross-linking agent, pigment, fiber etc., and

(ii) wet-component comprising

30-70 weight % polymer,

0-10 weight % additives selected from one or more of anti-foaming agents, thickeners, activator, cross-linking agent, pigments etc., and water up to 100 weight %.

11: A two component (2K) sealing slurry system composition of items 10, wherein the ratio of dry component (i) to wet component (ii) is found in the range of 1:2-4:1.

12: A composition of any one of the items 1-11, further comprising one or more cross-linking components, such as soluble salts of multivalent cations like calcium, aluminium, or zinc

13: A composition of any one of the items 1-12, further comprising one or more puzzolanic components.

14: A composition of any one of the items 1-13, further comprising an activator, preferably an alkaline activator selected from one of calcium hydroxide, sodium hydroxide, ordinary Portland cement or water soluble silicate compounds selected from sodium silicate, potassium silicate, waterglass, aluminium silicate, calcium silicate, silicic acid, sodium metasilicate, potassium metasilicate and mixtures of two or more of these constituents, wherein generally the water soluble silicate compounds are selected from alkali metasilicates of the formula m SiO2.nM2O, wherein M is Li, Na, K and NH4, preferably Na or K, or a mixture thereof, m and n refer to moles and the ratio of m:n is in the range of about 0.9 to about 4, preferably about 0.9 to about 3.8, and more preferred about 0.9 to about 3.6, preferably the activator is calcium hydroxide.

15: A composition of any one of the items 1-14, that is free of anti-caking additives, such as silicium dioxide, calcium carbonate or the like.

16: The use of the compositions of any one of the items 1-15 in a process or method of making a flexible water-proofing membrane.

17: A flexible water-proofing membrane obtained by a process or method utilizing a composition of any one of the items 1-16.

18: A flexible water-proofing membrane obtained by a method or process of item 16 or 17.

19: A flexible crack-bridging water-proofing membrane obtained by a method or process of item 16 or 17.

20: The use of the compositions of any one of the items 1-15 as a flexible coating or water-proofing membrane for concrete or masonry structures.

21: A water-proofing membrane comprising the composition of claims 1-14 as a waterproof barrier substrate optionally having a base fabric or matrix of woven, knitted or non-woven natural, polymeric or glass fibers.

22: A water-proofing membrane of item 21 wherein the base fabric or matrix is coated with one or more coatings of the composition of claims 1-14 on one or both sides of the said base fabric or matrix.

22: A water-proofing membrane of item 21 wherein the base fabric or matrix is immersed in a bed of a composition of claims 1-14, the composition evenly spread out whereby the composition and base fabric or matrix combine and form a single foil or wallpaper-like element.

### EXAMPLES

Different types of cement were tested in a sand/limestone mixture (Ordinary Portland Cement (OPC), CSA (Belith), HAC (i) (e.g. Ternal® white) HAC (ii) (Ternal® RG-S) and HAC (iii) (Istra 40). The thickener system used was a combination of cellulose and starch ethers. As a retardant system a combination of tartaric and citric acid was used. Open time was adjusted via retardant system to lie between 45 and 60 minutes. Two concentrations of cement were tested (5 weight % and 3 weight % of HAC, CAC, CSA)

The individual formulation of the tested slurry mixtures sample 1-13 was according to the following recipes:

| | 1 | 2 | 3 | 4 | 5 | 6 | 7 | 8 | 9 | 10 | 11 | 12 | 13 |
|---|---|---|---|---|---|---|---|---|---|---|---|---|---|
| OPC | 10 | 10 | 10 | 10 | 10 | 10 | 10 | 10 | 250 | 10 | | | 50 |
| CSA | 50 | | | | 30 | | | | | 40 | | 50 | |
| HAC (i) | | 50 | | | | 30 | | | | | | | |
| HAC (ii) | | | 50 | | | | 30 | | | | | | |
| HAC (iii) | | | | 50 | | | | 30 | 50 | | | | |
| Alpha hemi hydrate | | | | | | | | | | 5 | | | |
| Quarzsand 0.06-0.2 mm | 305 | 305 | 305 | 305 | 305 | 305 | 305 | 305 | | 300 | | 305 | 305 |
| Quarzsand 0-0.355 mm | 260 | 260 | 260 | 260 | 260 | 260 | 260 | 260 | 376 | 260 | | 260 | 260 |
| Quarzsand 0.2-0.6 mm | 125 | 125 | 125 | 125 | 125 | 125 | 125 | 125 | 109 | 125 | | 125 | 125 |
| limestone powder | 52 | 52 | 52 | 52 | 72 | 72 | 72 | 72 | 25 | 52 | 518 | 62 | 62 |
| (Omyacarb 15AL) | | | | | | | | | | | | | |
| Microsilika (940U) | 8 | 8 | 8 | 8 | 8 | 8 | 8 | 8 | 8 | 8 | | 8 | 8 |
| styrene acrylate powder | 180 | 180 | 180 | 180 | 180 | 180 | 180 | 180 | 180 | 180 | | 180 | 180 |
| (Acronal ® P5033) | | | | | | | | | | | | | |
| Styrene acrylate | | | | | | | | | | | 468 | | |
| dispersion | | | | | | | | | | | | | |
| (Acronal 5041) | | | | | | | | | | | | | |
| (50% solid content) | | | | | | | | | | | | | |
| Powder defoamer | 8 | 8 | 8 | 8 | 8 | 8 | 8 | 8 | 8 | 8 | | 8 | 8 |
| (Vinapor DF9010) | | | | | | | | | | | | | |
| Cellulose Ether | 1.2 | 1.2 | 1.2 | 1.2 | 1 | 1 | 1 | 1 | 1 | 1.2 | | 1.2 | 1.2 |
| (Walocel MW 40000) | | | | | | | | | | | | | |
| Starch Ether | 0.8 | 0.8 | 0.8 | 0.8 | 0.6 | 0.6 | 0.6 | 0.6 | 0.8 | 0.8 | | 0.8 | 0.8 |
| (Starvis SE 35F) | | | | | | | | | | | | | |
| Acrylic thickener | | | | | | | | | | | 2.5 | | |
| (Rheovis AS1130) | | | | | | | | | | | | | |
| Pigment disperser | | | | | | | | | | | 5 | | |
| (Dispex CX 4320) | | | | | | | | | | | | | |
| Liquid defoamer | | | | | | | | | | | 2 | | |
| (Foamstar NO 2306) | | | | | | | | | | | | | |
| Retarder (tartaric acid) | 0.15 | 0.1 | 0.2 | 0.1 | | | 0.28 | | 0.25 | | | 0.1 | |
| Pigment TiO2 | | | | | | | | | | | 5 | | |
| (Kronos 2056) | | | | | | | | | | | | | |
| Retarder (citric acid) | 0.15 | 0.1 | 0.2 | 0.1 | 0.25 | 0.2 | 0.2 | 0.2 | 0.25 | 0.15 | | 0.1 | |
| Sum | 1000.3 | 1000.2 | 1000.4 | 1000.2 | 999.85 | 999.8 | 1000.1 | 999.8 | | | 1000 | 1000.2 | 1000 |
| Water | 212 | 204 | 212 | 216 | 180 | 180 | 192 | 180 | 200 | | | 205 | 205 |
| pot life | 60 min | 50 min | 60 min | 60 min | 45 min | 45 min | 45 min | 45 min | 45 min | 45 min | ∞ | 45 min | 24 h |
| Film flexibility, cohesion | High, | High, | High, | High, | High, | High, | High, | High, | High | mid | Very | Very | High, |
| | good | good | good | good | good | good | good | good | Good | good | high, | high, | middle |
| | | | | | | | | | | | good | good | |
| Static Crack bridging | 0.6 | 0.6 | 0.6 | 0.6 | 0.8 | 0.8 | 0.8 | 0.8 | 0.2 | 0.5 | 1.8 | 0.8 | 0.6 |
| [mm] | | | | | | | | | | | | | |
| Film after water | No | No | No | No | No | Mid | Mid | Mid | No | Mid | No | Mid | High |
| storage (14 d) | leaching | leaching | leaching | leaching | leaching | leaching | leaching | leaching | leaching | leaching | leaching | leaching | leaching |

Films of a thickness of 2.4 mm were produced by a wiper on a Teflon foil as illustrated in FIG. 1. After drying (7 days) the films were stored submersed in water for 14 days. Cohesion and leaching of the films was observed during this time.

Leaching Tests:

Leaching behavior was tested by storage of films submersed in water for up to 14 days. The different film-types demonstrate different leaching characteristics. The degree of leaching was assessed by the coloring intensity of the residual water.

Sample 1, film made of 5 weight %-CSA/HAC Cement reveals no leaching. Sample 2 and 4 reveal strongest leaching. The leaching behavior of Sample 3 lies between the leaching result of sample 1 and 4 after visual inspection (FIG. 2).

Manual Flexibility and Cohesion Test

A film was produced as depicted in FIG. 1. After drying under normal conditions (23° C./50% relative humidity for 7 days) the film was rated by hand by manually rolling and stretching the resulting membrane.

Cohesion tests demonstrated good flexibility properties (FIG. 4) and good cohesion properties (FIG. 5) after wet storage as confirmed by manual testing.

Film Samples 5-8 have a cement content of 3 weight % CSA/HAC cement. The observed leaching is stronger as in samples 1-4. Only sample 5 with CSA cement shows no leaching.

Film cohesion of film 6 and 8 is weak while cohesion properties of film 5 and 7 are good.

In conclusion the absorption rate with CSA cement is best in field and allows cement reduced formulations lower than 5 weight % of cement with a sufficient water stability.

Crack-Bridging Test

A mortar prism with an integrated steel wire was produced and dried for 28 days. After drying the water-proofing membrane was applied in two layers of approx. 1.2 mm thickness per layer. After drying of the water-proofing membrane for 28 days under normal conditions (23° C./50% r.H.) the Crack-bridging Test was performed.

In a time period of approximately 15 minutes a crack of 0.4 mm was slowly produced via a screw in a standard crack bridging equipment. Crack dimensions were measured via a loupe or magnifying glass with an integrated scale. The crack was fixed over 24 hours and the behavior of crack-bridging properties of the applied water-proofing membrane was observed. The test was considered a Pass once no crack was visible on the membrane after the observation period. Otherwise if the water-proofing membrane cracked or tore over the mortar-based crack after the evaluation time the test was considered as Failure.

Prefabricated Flexible Water-Proofing Membranes

Formulation for Cementitious Slurry

OPC 5

CSA 30

HAC (i)

HAC (ii)

HAC (iii)

Alpha hemi hydrate

Quarzsand 0.06-0.2 mm 333

Quarzsand 0-0.355 mm130

Quarzsand 0.2-0.6 mm 152

limestone powder (Omyacarb 15AL) 103

Powder defoamer (Vinapor DF9010) 2

Acrylic thickener (Rheovis HS 1980) 0.4

(mesh mesh

Styrene acrylate dispersion (Acronal 5442)(50% solid content) 460

Liquid defoamer (Foamaster 512213) 4

pot life 15 min

Film flexibility, cohesion Very high, very good

Static Crack bridging [mm] 3 mm

Film after water storage (14d) No leaching

Prefabricated flexible water-proofing membranes or waterproofing wallpaper foil of a thickness of up to 1 mm was produced by immersing a mesh into a bed of cementitious slurry of the formulation as described above, followed by spreading the slurry into a thin and even membrane as illustrated in FIG. 7. After drying (7 days) the single membrane or film (FIG. 8) was applied onto a surface using an adhesive as Illustrated in FIG. 9. The membrane provides excellent crack-bridging properties as illustrated in FIG. 10.

### BRIEF DESCRIPTION OF THE DRAWINGS

FIG. 1 Film preparation utilizing wiper with 2.4 mm notch

FIG. 2 Leaching test results of 5 weight % CSA-films stored in water

FIG. 3 Leaching test results of 3 weight % CSA-films stored in water

FIG. 4 Flexibility Test; (a) Pass, (b) Failure

FIG. 5 Manual Cohesion Test; (a) Pass, (b) Failure

FIG. 6: Crack-bridging Test; (a) Pass, (b) Failure

FIG. 7: Cementitious water-proofing slurry and matrix

FIG. 8: Prefabricated flexible water-proofing membranes

FIG. 9: Use of prefabricated flexible water-proofing membranes

FIG. 10: Crack bridging properties of the wallpaper foil

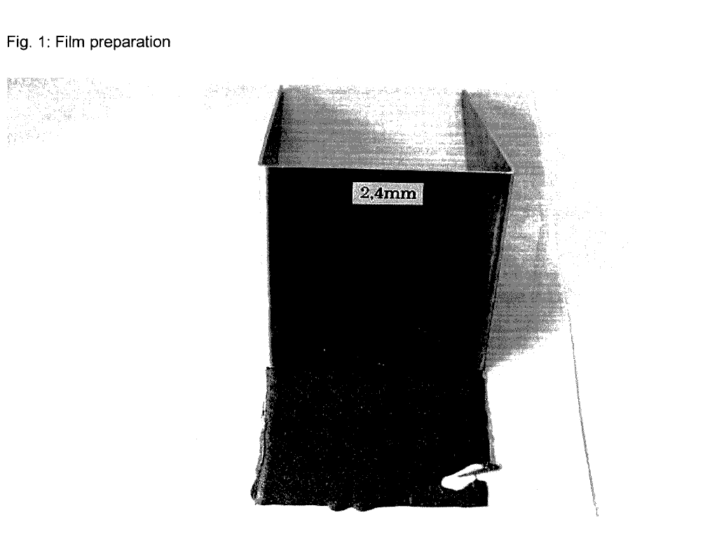

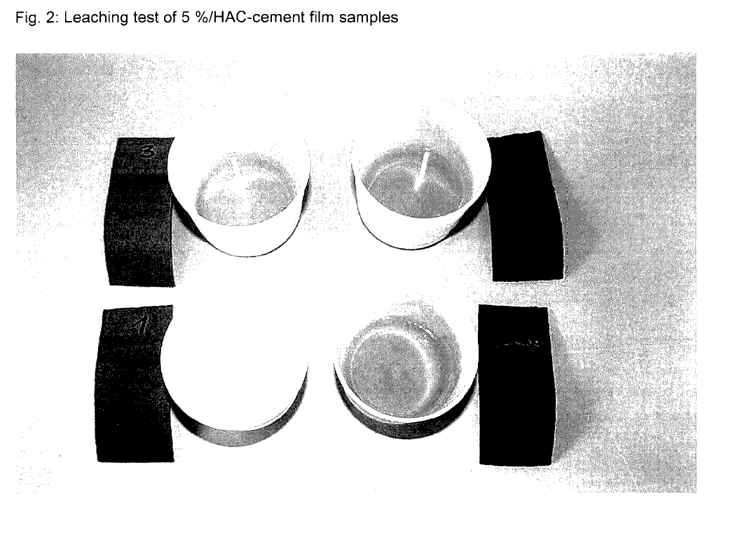

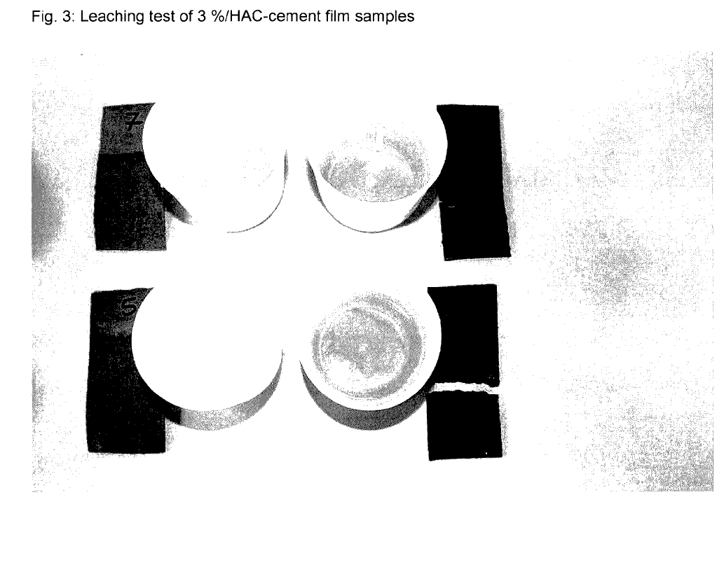

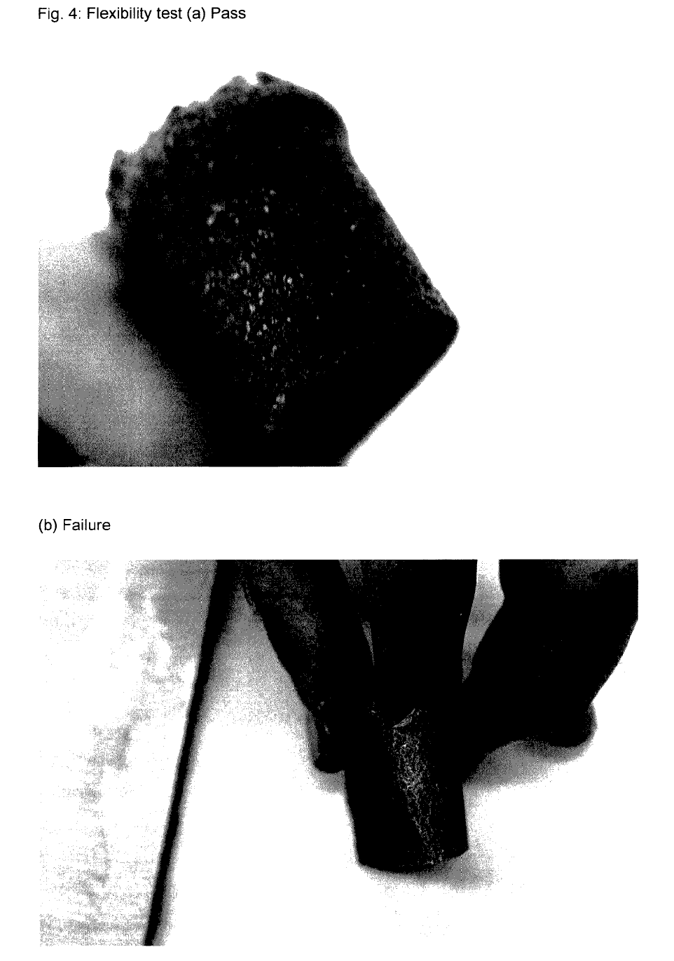

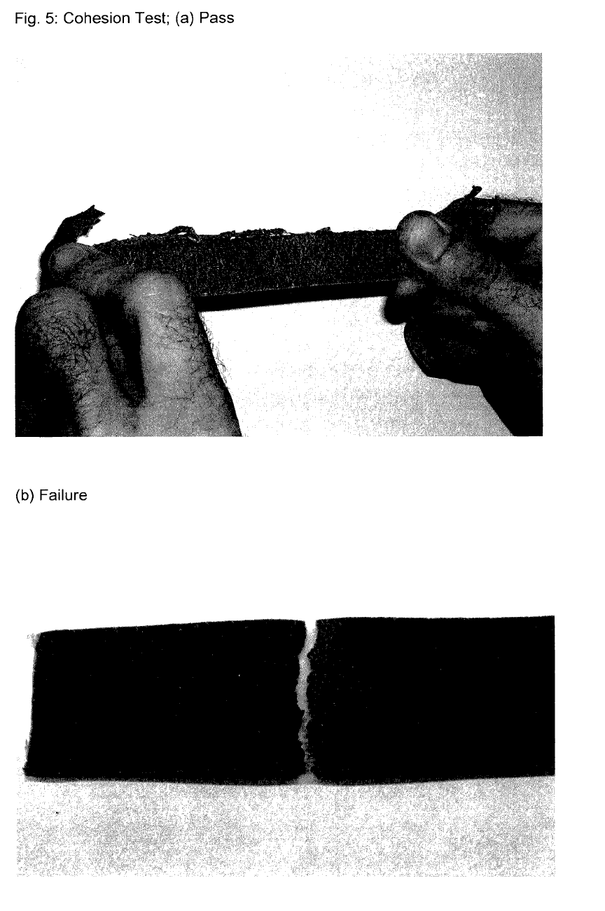

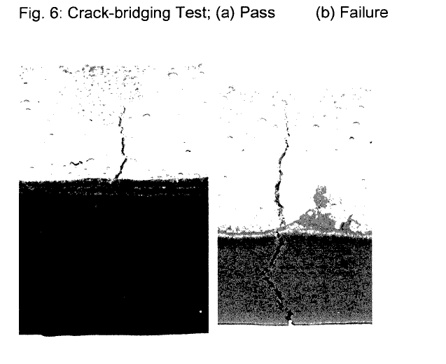

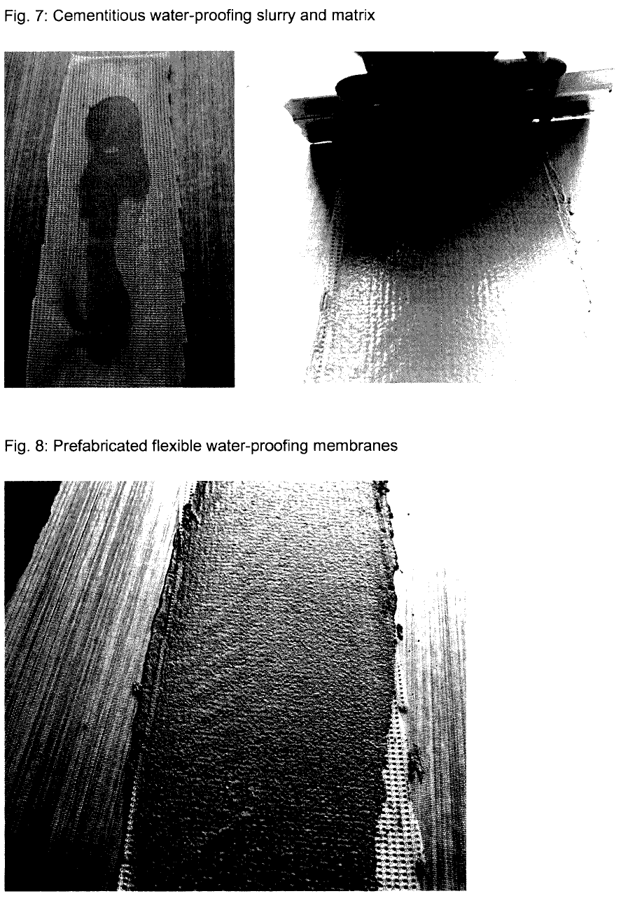

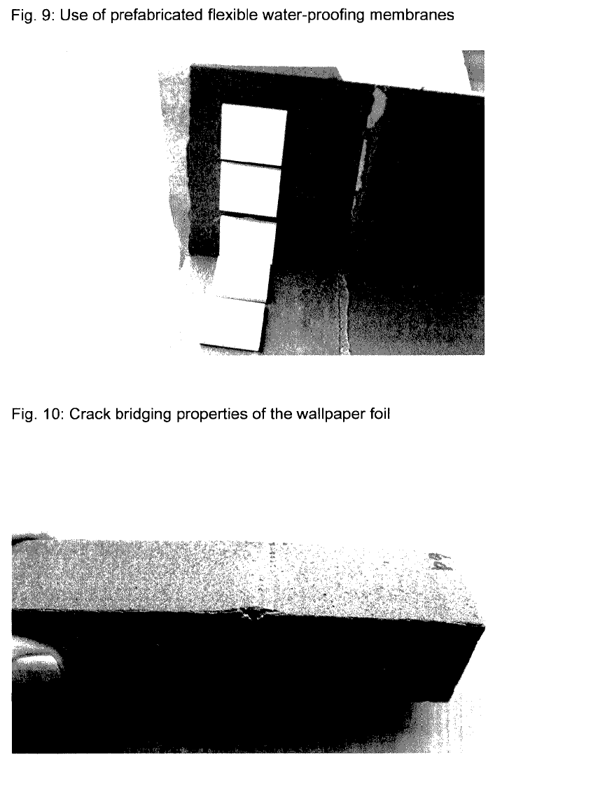

1: A composition for sealing slurries comprising:
(i) 1-45 weight % hydraulic binder
(ii) 40-77 weight % silica sand
(iii) 10-40 weight % polymer
(iv) 5-20 weight % limestone powder
(v) 0-7 weight % one or more additives
wherein the hydraulic binder component comprises calcium aluminate cement, calcium sulfoaluminate cement or mixtures thereof and the polymer is selected from the group consisting of vinyl acetate polymer, vinyl acetate-ethylene copolymer, vinyl acetate-vinyl ester copolymer and vinyl acetate-vinyl ester-ethylene copolymer, with the vinyl ester monomers in each case being selected from the group consisting of vinyl laurate, vinyl pivalate, vinyl versatates, vinyl acetate-acrylic ester copolymer, vinyl acetate-acrylic ester-ethylene copolymer, styrene-butadiene copolymer, styrene-acrylic ester copolymer, and styrene acrylate copolymer, with the acrylic esters in each case being esters with branched or linear alcohols comprising from 1 to 10 carbon atoms.

2: The composition of claim 1, wherein the hydraulic binder component consists essentially of calcium aluminate cement, calcium sulfoaluminate cement or mixtures thereof.

3: The composition of claim 1, wherein the hydraulic binder component comprises up to 100 weight % calcium aluminate cement, calcium sulfoaluminate cement or mixtures thereof.

4: The composition of claim 3, wherein the hydraulic binder component comprises up to 80 weight % calcium sulfoaluminate cement and is free of Portland cement.

5: The composition of claim 1, wherein the hydraulic binder component further comprises Portland cement.

6: The composition of claim 5, wherein Portland cement and calcium sulfoaluminate cement are present in a ratio of 0.5-0.1.

7: The composition of claim 1, wherein calcium aluminate cement and calcium sulfoaluminate cement are present in a ratio of 1:5.

8: The composition of claim 1, wherein the polymer comprises styrene acrylate or an acrylate copolymer.

9: The composition of claim 1, wherein the ratio of polymer to hydraulic binder component is larger than 1.

10: The composition of claim 1, comprising:
(i) a dry component comprising:
5-20 weight % lime stone powder;
40-77 weight % silica sand,
1-50 weight % hydraulic binder component,
0-10 weight 0% additives selected from the group consisting of anti-foaming agents, thickeners, activator, cross-linking agent, pigment, and fiber, and
(ii) a wet-component comprising:
30-70 weight % polymer,
0-10 weight % additives selected from the group consisting of anti-foaming agents, thickeners, activator, cross-linking agent, pigments, and water up to 100 weight %.

11: The composition of claim 10, wherein the ratio of dry component (i) to wet component (ii) is in the range of 1:2-3:1.

12: The composition of claim 1, further comprising one or more cross-linking components.

13: The composition of claim 1, further comprising one or more puzzolanic components.

14: The composition of claim 1, further comprising an alkaline activator selected from the group consisting of calcium hydroxide, sodium hydroxide, ordinary Portland cement and water soluble silicate compounds.

15: The composition of claim 1, that is free of anti-caking additives.

16. (canceled)

17: A flexible water-proofing membrane comprising the composition of claim 1.

18: A flexible water-proofing membrane obtained from a sealing slurry comprising the composition of claim 1.

19: A method of sealing a concrete or masonry structure, comprising applying to the concrete or masonry structure a flexible coating or a water-proofing membrane comprising the composition of claim 1.

20: A flexible water-proofing membrane comprising a sealing slurry and a base matrix or mesh selected from the group consisting of a woven matrix or mesh, a knitted or non-woven natural matrix or mesh, and a polymeric or glass fiber matrix or mesh.
